(19) United States
(12) Patent Application Publication
(10) Pub. No.: US 2024/0129403 A1
(43) Pub. Date: Apr. 18, 2024

(54) DUMMY NODE MANAGEMENT IN EDGE COMPUTING

(71) Applicant: Dell Products L.P., Round Rock, TX (US)

(72) Inventors: Bruce Bin HU, Shanghai (CN); Baoli CHEN, Shanghai (CN); Haijun ZHONG, Shanghai (CN); John WU, Shanghai (CN); Rui JIANG, Shanghai (CN)

(73) Assignee: Dell Products L.P., Round Rock, TX (US)

(21) Appl. No.: 17/976,478

(22) Filed: Oct. 28, 2022

(30) Foreign Application Priority Data
Oct. 14, 2022 (CN) 202211264702.1

(51) Int. Cl. H04M 1/72403; G06F 3/0489

(52) U.S. Cl. CPC H04M 1/72403; G06F 3/04897

(57) ABSTRACT

An information handling system may include at least one processor and a memory. The information handling system may be configured to: receive a request to perform a management operation on a target information handling system, wherein the request is received from a mobile device via a mobile network, and wherein the request includes data retrieved from a visual identifier associated with the target information handling system; and perform the management operation by communicating with the target information handling system via a management network other than the mobile network.

### TECHNICAL FIELD

The present disclosure relates in general to information handling systems, and more particularly to techniques for management of dummy nodes in edge computing scenarios.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Some HCI systems are used to support edge computing scenarios, which may include HCI satellite nodes as edge nodes. Some or all of such edge nodes may be “dummy” nodes, which means that they do not include local input/output hardware such as a local display, a keyboard, a mouse, etc.

An HCI management system may be used to manage these dummy nodes centrally, and a local administrator may sometimes need to perform certain operations on-site at the geographical location of a dummy node. For example, the administrator may need to check information about a dummy node's status, change configuration settings, etc. Embodiments of this disclosure provide improvements in the field of performing such management.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with dummy node management in information handling systems may be reduced or eliminated.

In accordance with embodiments of the present disclosure, an information handling system may include at least one processor and a memory. The information handling system may be configured to: receive a request to perform a management operation on a target information handling system, wherein the request is received from a mobile device via a mobile network, and wherein the request includes data retrieved from a visual identifier associated with the target information handling system; and perform the management operation by communicating with the target information handling system via a management network other than the mobile network.

In accordance with these and other embodiments of the present disclosure, a method may include an information handling system receiving a request to perform a management operation on a target information handling system, wherein the request is received from a mobile device via a mobile network, and wherein the request includes data retrieved from a visual identifier associated with the target information handling system; and the information handling system performing the management operation by communicating with the target information handling system via a management network other than the mobile network.

In accordance with these and other embodiments of the present disclosure, an article of manufacture may include a non-transitory, computer-readable medium having computer-executable instructions thereon that are executable by a processor of an information handling system for: receiving a request to perform a management operation on a target information handling system, wherein the request is received from a mobile device via a mobile network, and wherein the request includes data retrieved from a visual identifier associated with the target information handling system; and performing the management operation by communicating with the target information handling system via a management network other than the mobile network.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example architecture, in accordance with embodiments of the present disclosure; and

FIGS. 3-7 illustrate sequence diagrams, in accordance with embodiments of this disclosure.

### DETAILED DESCRIPTION

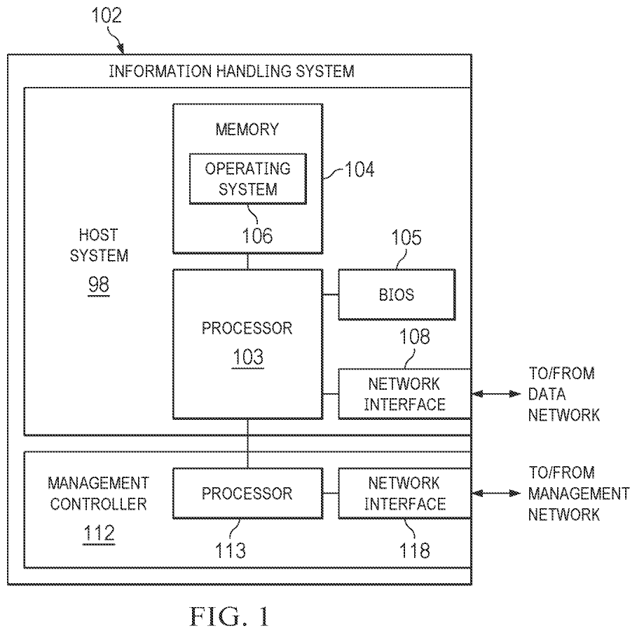

Preferred embodiments and their advantages are best understood by reference to FIGS. 1 through 7, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in the field of managing dummy nodes, which may be particularly useful in the context of edge computing scenarios implemented via an HCI system.

In one embodiment, dummy edge HCI nodes may be managed via an HCI management system and a mobile client (e.g., executing on a mobile device with a camera such as a smartphone), through the use of a visual identifier (e.g., a bar code, QR code, etc.) on each dummy node. For the sake of clarity and concreteness, this disclosure discusses the example of QR codes in detail, but one of ordinary skill with the benefit of this disclosure will appreciate its applicability to other types of visual identifier. In one embodiment, the QR code is used to uniquely identify the particular dummy node (e.g., by including a service tag or other unique device identifier). The QR code may be displayed dynamically (e.g., a changeable code displayed on a display device such as a monitor, a small LCD display, etc.) or statically (e.g., a code printed on a label).

The HCI management system may collect information regarding the dummy nodes via an HCI management network. The mobile client may be implemented on any suitable mobile equipment with QR scanner functionality. The mobile client may be registered on the HCI management system, and it may communicate with the HCI management system via a separate mobile management network such as a 5G network.

In operation, an administrator at the site of a dummy node may scan the node's QR code and then perform management tasks via the mobile client. For example, the mobile client may display operational data about the node, allow configurations to be changed, etc.

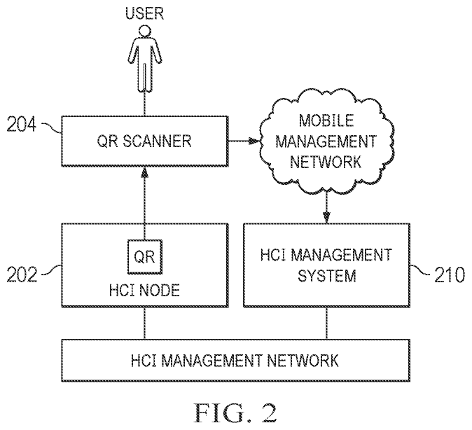

FIG. 2 illustrates an example architecture for performing such management as described above. A user at the site of a dummy node may use QR scanner 204 to scan a QR code displayed at HCI node 202. HCI node 202 may be in communication with the central HCI management system 210 via the HCI management network, and QR scanner 204 may be in communication with the HCI management system 210 via a mobile management network.

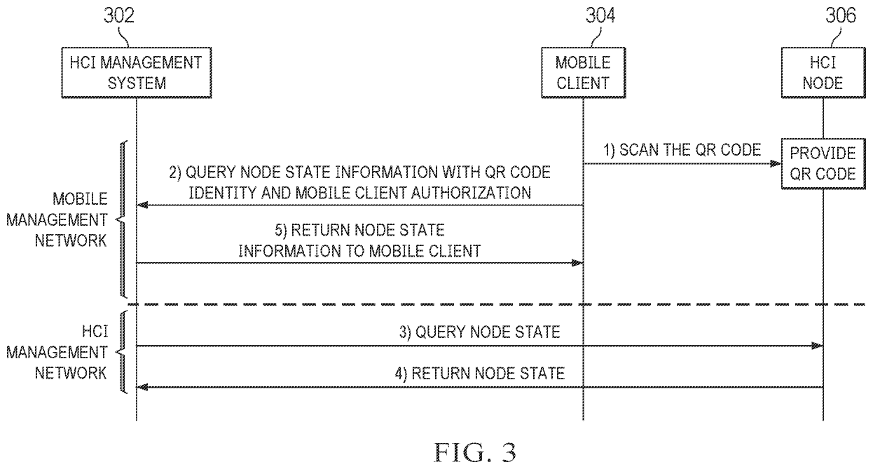

FIGS. 3-7 present sequence diagram methods for various scenarios, according to some embodiments.

In FIG. 3, an administrator is querying the state of an HCI dummy node. The administrator uses a mobile client 304 to scan a QR code from HCI node 306 at step 1. Mobile client 304 communicates with HCI management system 302 via the mobile management network to query the node state at step 2. In particular, mobile client 304 may provide the QR code it has scanned, as well as information (e.g., a certificate) establishing that it has been pre-authorized with the HCI management system 302.

HCI management system 302 may then communicate with HCI node 306 via the HCI management network at steps 3-4 to retrieve the node state. HCI management system 302 may then transmit the result to mobile client 304 via the mobile management network at step 5.

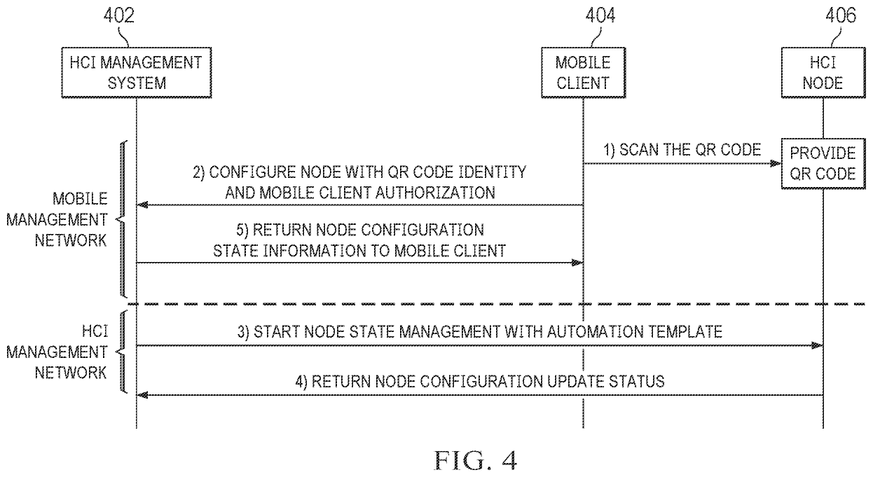

FIG. 4 illustrates a scenario similar to FIG. 3. However, while in FIG. 3 the administrator is querying the state of the HCI node, in FIG. 4, the administrator is making a configuration change to the HCI node.

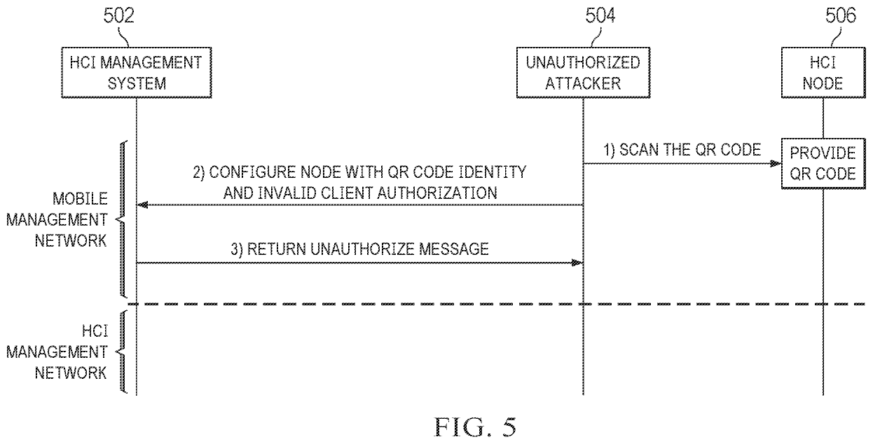

FIG. 5 illustrates a scenario similar to FIG. 4. However, while in FIG. 4 the mobile client that is making the request has been pre-authorized, in FIG. 5, an unauthorized attacker is attempting to perform the method. In this scenario, HCI management system 502 determines that the attacker is unauthorized and does not permit the configuration change to take place.

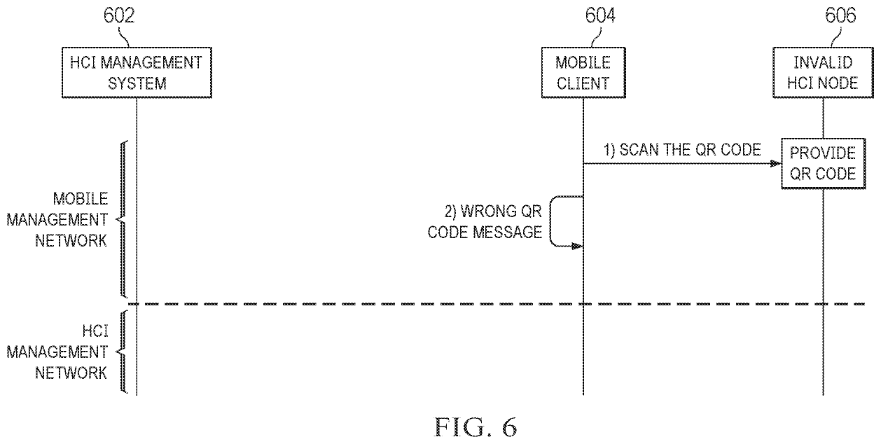

FIG. 6 illustrates a scenario in which an invalid QR code is presented to mobile device 604. For example, the QR code may have an invalid checksum or it may be of an improper format. In this situation, mobile device 604 may reject the query immediately without the need for communicating with HCI management system 602.

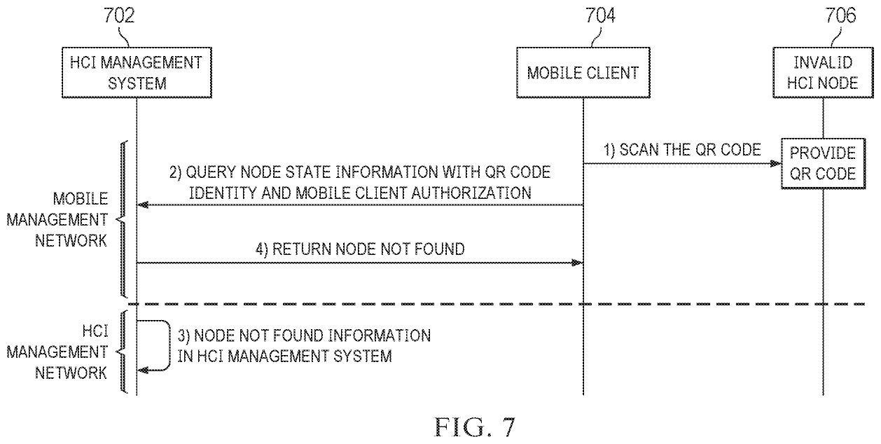

FIG. 7 illustrates a scenario in which a valid but incorrect QR code is presented to mobile device 704. In this situation, mobile client 704 is unable to determine immediately that the QR code is incorrect, and so it proceeds to query HCI management system 702. HCI management system 702 determines that no valid HCI node corresponds to the QR code, and so the request fails.

One of ordinary skill in the art with the benefit of this disclosure will understand that the preferred initialization point for the methods depicted in FIGS. 3-7 and the order of the steps comprising those methods may depend on the implementation chosen. In these and other embodiments, the methods may be implemented as hardware, firmware, software, applications, functions, libraries, or other instructions. Further, although FIGS. 3-7 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. An information handling system comprising:
at least one processor; and
a memory;
wherein the information handling system is configured to:
receive a request to perform a management operation on a target information handling system, wherein the management operation includes changing a configuration setting of the target information handling system, wherein the request is received from a mobile device via a mobile network, and wherein the request includes a certificate indicating that the mobile device has been pre-authorized with the information handling system and further includes data retrieved from a visual identifier associated with the target information handling system; and
perform the management operation by communicating with the target information handling system via a management network other than the mobile network.

2. The information handling system of claim 1, wherein the target information handling system is a dummy system that does not include a keyboard or a mouse.

3. The information handling system of claim 2, wherein the dummy system does not include a display device.

4. The information handling system of claim 1, wherein the visual identifier is provided via a display device of the target information handling system.

5. The information handling system of claim 1, wherein the visual identifier is provided via a printed label.

6. The information handling system of claim 1, wherein the target information handling system is a node of a hyper-converged infrastructure (HCI) system.

7. A method comprising:
an information handling system receiving a request to perform a management operation on a target information handling system, wherein the management operation includes changing a configuration setting of the target information handling system, wherein the request is received from a mobile device via a mobile network, and wherein the request includes a certificate indicating that the mobile device has been pre-authorized with the information handling system and further includes data retrieved from a visual identifier associated with the target information handling system; and
the information handling system performing the management operation by communicating with the target information handling system via a management network other than the mobile network.

8. The method of claim 7, wherein the target information handling system is a dummy system that does not include a keyboard or a mouse.

9. The method of claim 8, wherein the dummy system does not include a display device.

10. The method of claim 7, wherein the visual identifier is provided via a display device of the target information handling system.

11. The method of claim 7, wherein the visual identifier is provided via a printed label.

12. The method of claim 7, wherein the target information handling system is a node of a hyper-converged infrastructure (HCI) system.

13. An article of manufacture comprising a non-transitory, computer-readable medium having computer-executable instructions thereon that are executable by a processor of an information handling system for:
receiving a request to perform a management operation on a target information handling system, wherein the management operation includes changing a configuration setting of the target information handling system, wherein the request is received from a mobile device via a mobile network, and wherein the request includes a certificate indicating that the mobile device has been pre-authorized with the information handling system and further includes data retrieved from a visual identifier associated with the target information handling system; and
performing the management operation by communicating with the target information handling system via a management network other than the mobile network.

14. The article of claim 13, wherein the target information handling system is a dummy system that does not include a keyboard or a mouse.

15. The article of claim 14, wherein the dummy system does not include a display device.

16. The article of claim 13, wherein the visual identifier is provided via a display device of the target information handling system.

17. The article of claim 13, wherein the visual identifier is provided via a printed label.

18. The article of claim 13, wherein the target information handling system is a node of a hyper-converged infrastructure (HCI) system.
